(19) United States
(12) Patent Application Publication
(10) Pub. No.: US 2007/0001487 A1
(43) Pub. Date: Jan. 4, 2007

(54) REAR WINDOW IN A REAR ROOF SECTION OF AN OPENABLE ROOF VEHICLE

(75) Inventors: Thomas Halbweiss, Remseck (DE); Wojciech Wezyk, Sindelfingen (DE)

Correspondence Address: BROOKS KUSHMAN P.C., 1000 TOWN CENTER, TWENTY-SECOND FLOOR, SOUTHFIELD, MI, 48075, US

(73) Assignee: CTS FAHRZEUG-DACHSYSTEME GMBH, Bietigheim-Bissingen (DE)

(21) Appl. No.: 11/425,842

(22) Filed: Jun. 22, 2006

(30) Foreign Application Priority Data
Jun. 22, 2005 (DE) 10 2005 029 301.8

(51) Int. Cl. B60J 7/00

(52) U.S. Cl. 296/219

(57) ABSTRACT

A rear window for a flexible rear roof section of an openable roof vehicle. The rear window is comprised of a transparent plastic material such as a polycarbonate material, and a fastening section that connects the rear window to the flexible covering of the open roof vehicle. The fastening section forms a single piece with the rear window and is offset relative to the plane of the rear window.

### CROSS-REFERENCE TO RELATED APPLICATIONS

This application claims priority to German application Serial No. 10 2005 029 301.8 filed Jun. 22, 2005.

### BACKGROUND OF THE INVENTION

1. Field of the Invention

The present invention relates to a rear window in a rear roof section of an openable roof vehicle.

2. Background Art

Rear windows in the rear roof section of an openable roof vehicle give motor vehicle drivers the ability to see clearly toward the rear, even when the vehicle roof is closed. Rear windows in the rear roof section of an openable roof vehicle have a fastening section to connect the rear window to a flexible covering of the vehicle roof.

German Application DE 41 29 492 A1 discloses a method for connecting a rear window with the flexible covering of an openable roof vehicle. This patent requires the use of an adhesive that connects the rear window to a frame. Bolts are used to connect the frame to the flexible covering of the vehicle roof. The disadvantage with this patent is that the frame and the bolts necessary to fasten the flexible covering not only are clearly visible but also protrude. Thus, this design not only spoils the visual appearance, but also could represent a safety risk.

German application DE 42 10 487 A1 discloses another way to connect a rear window with the flexible covering in an openable roof vehicle. However, this patent requires additional design and assembly expense in order to cover the necessary functional parts and additional interior covering.

German application DE 196 28 107 C1 discloses a third method of connecting a rear window with the flexible covering of an openable roof vehicle. This patent requires the rear window be connected with the flexible covering of the vehicle roof by means of an additional sealing frame engaging two plastic profiles. Here, the additional sealing frame and plastic profiles are required to connect the rear window with the flexible covering. The disadvantage with this patent is that these functional connecting elements are clearly visible from both the inside and outside.

The present invention is an improvement over the above references, as summarized below.

### SUMMARY OF THE INVENTION

One objective of this invention is to improve the visual appearance and integration of the functional parts necessary for connecting the rear window with the covering of the vehicle roof of an openable roof vehicle.

One advantage of the invention is that the outside surface of the rear window is flush with the flexible covering of the openable vehicle roof in the area of the fastening section. The entire outside surface is smooth except for the visible seam that represents the flush transitional area between the outside rear window and the flexible covering. The invention provides an advantage in visual appearance because the transitional area is flush with the roof surface.

Another advantage of the invention is that the rear window may have different wall thicknesses. The rear window can have a lower wall thickness toward its middle for weight optimization. In addition, the fastening section of the rear window can have a thinner wall thickness. Furthermore, this step in the thickness of the rear window allows an offset that accommodates the functional parts that connect the flexible covering and the rear window. To accomplish this seamless transition, the wall thickness of the rear window can be conically tapered down to a thickness close to zero in the direction of the flexible covering. This offset creates a seamless transition between the rear window and the flexible covering from the inside.

A further advantage of the invention is that the fastening section of the rear window may have an offset that lies in a plane that is different than that of the rear window. This offset allows the rear window to have the same wall thickness near its fastening section, but requires a drop or bend in order to accommodate the flexible covering and/or the necessary functional elements. Thus, the offset allows a flush connection between the rear window, the flexible covering, and the functional elements.

Another advantage of the invention is that the fastening section may have an upward bend which makes the rear window more stable, and provides a better connection between the rear window and the flexible covering. The upward bend can be at a certain angle, preferably up to 90°. In addition, the upward bend is provided in the fastening section of the rear window. Furthermore, the flexible covering of the vehicle roof should be located on the upward bend.

Another advantage of this invention is that the rear window can be produced using a polycarbonate (PC) injection molding. Furthermore, polycarbonate has properties which are favorable for vehicle construction and is easy to provide in an injection molded process. In addition, the injection mold can be designed in such a way that the rear window produced has a shape that is beneficial for later installation in an openable roof vehicle. Some examples of a beneficial injection molded rear window include an offset, a step, and/or different wall thickness. Therefore, economical benefits are gained in using an injection mold in the production of the rear window.

Other advantages and improvements achieved by the Applicants' invention will be apparent to one of ordinary skill in the art in view of the attached drawings and following detailed description of the illustrated embodiment.

### BRIEF DESCRIPTION OF THE DRAWINGS

FIG. 1 is a perspective view of a vehicle that has a rear window in a rear roof section of an openable roof vehicle;

FIG. 2 is a cross-section view of an integrated rear window having an offset in the area of the fastening section of the rear roof section;

FIG. 3 is a cross-section view of a rear window, similar to FIG. 2, having a material thickness offset formed in the rear window;

FIG. 4 is a rear window view similar to those shown in FIGS. 2 and 3 having the offset formed in the rear window by a step in material thickness, and wherein the material thickness of the rear window tapers toward the flexible covering of the rear roof section; and

FIG. 5 is a rear window similar to those shown in FIGS. 2-4 having the offset formed in the rear window that has a step in material thickness on one end of the offset and a 90° upward bend on the other end of the offset.

### DETAILED DESCRIPTION OF THE PREFERRED EMBODIMENT

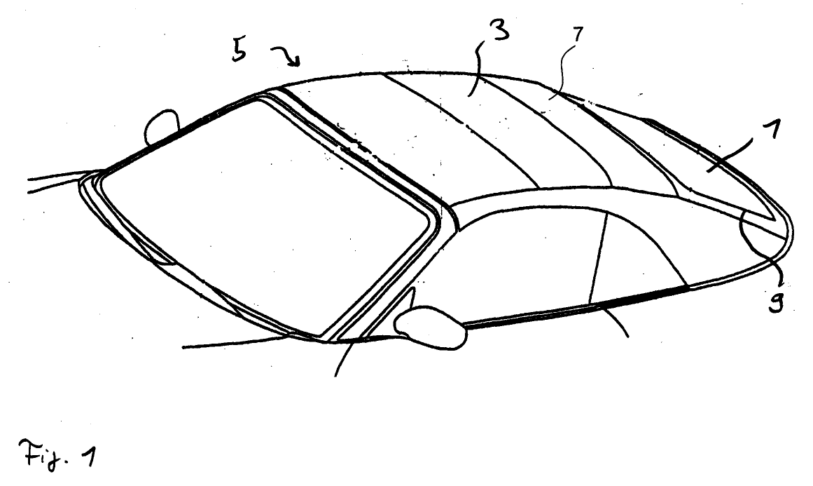

FIG. 1 shows a rear window 1, that is adapted to be installed into an openable vehicle roof 3 of a vehicle 5. FIG. 1 shows the vehicle 5 with the openable vehicle roof 3 in the closed position. The vehicle interior is covered by a vehicle roof 3 that is comprised of a flexible covering 7. The rear window 1 has a fastening section 9 where the rear window 1 is connected with the flexible covering 7 of the vehicle roof 3. The fastening section 9 has corresponding fasteners (not shown in FIG. 1), which may include foams, adhesives, clamps, clips, frames, bolts, rivets, or similar objects.

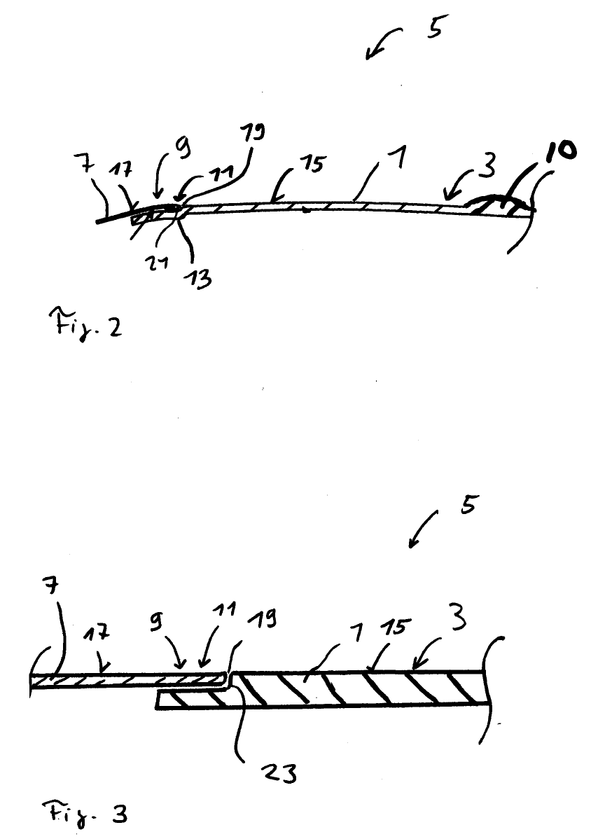

FIG. 2 shows a partial sectional illustration of the fastening section 9 of the rear window 1. The rear window 1 is made of a transparent material, so that it allows the driver a clear view toward the rear when vehicle roof 3 is closed. The transparent material used is a polycarbonate which is processed by injection molding. The injection molded polycarbonate parts can have drops, bends, changes in the wall thickness, and other advantageous embodiments. This makes it possible to optimize the weight by varying the material thickness toward the middle of the window. In areas where the geometric and kinematic properties of the vehicle roof 3 expose the rear window 1 to lower loads, it can have a relatively thin wall thickness. In addition, in some areas it is also possible to vary the wall thickness of the rear window in such a way as to produce optics that affect the path of the light. For example, it would be possible to integrally form a wide-angle lens 10 in a localized area of the rear window 1 that could reduce the existing blind spot of the vehicle 5. The localized area may have a convex or concave configuration formed during the injection molding process that forms the rear window 1.

FIG. 2 further illustrates an offset 11 between the rear window 1 and the fastening section 9. The offset 11 is realized by means of a bend 13. The bend 13 is designed in such a way that it lowers the outer surface 15 of the rear window 1. The offset extends approximately parallel to that of the rear window. When viewed in the orientation of FIG. 2, the fastening section 9 of rear window 1 is located to the left of the bend 15 of the rear window 1. The offset 11 is designed in such a way that the fastening elements (not shown in FIG. 2) and a flexible covering 7, that borders the rear window 1, are flush. The offset 11 allows an outer surface 17, of the flexible covering 7, and an outer surface 15, of the rear window 1, to be flush at a seam 19 where they meet. As shown in FIG. 2, the flexible covering 7 has a fold 21 in the area of seam 19.

FIG. 3 shows a further illustration of the rear window 1. In an area of the seam 19 where the fastening section 9 meets the rear window 1, a step in material thickness occurs, producing a step 23 in the rear window. The offset 11 is provided by the step 23 in which is received the flexible covering 7 and the fasteners (not shown). The outer surfaces 17 and 15 of the covering 7 and the rear window 1 are flush where they meet at the seam 19. The height of the step 23 of the rear window 1 can be adapted to the thickness of the covering 7 and the fasteners (not shown). The offset 11 at the step 23 may have any depth or height to reduce the seam 19 that would otherwise visually stand out without the offset.

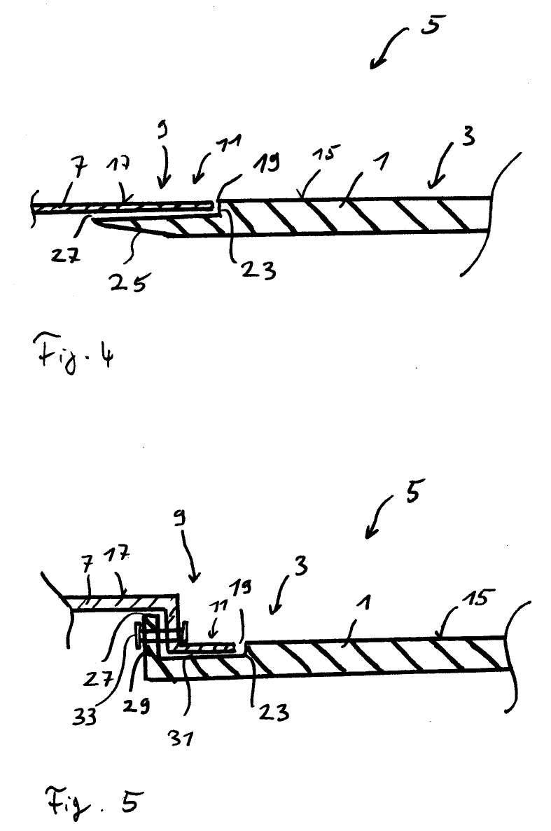

FIG. 4 illustrates another embodiment of the rear window 1 in which the offset 11 of the rear window 1 may contain a taper 25 in the thickness of the material. If no additional ceiling is provided, taper 25 of the rear window 1 is visible from the vehicle interior. Taper 25 makes it possible for the interior transition 27 between the rear window 1 and the flat covering 7 to have a substantially flush visual appearance.

FIG. 5 illustrates an upward bend 29 at the offset 11 of the rear window 1. The upward bend 29 located at the outer edge of rear window 1 that stands at an angle to outer surface 15 or to surface 31. It is preferable for the upward bend 29 to form an angle of up to 90° relative to surfaces 15 and 31. The upward bend 29 can have corresponding fastening elements 33 to fix the covering 7 to the rear window 1. However, the area of the surface 31 of the offset 11 located in the fastening section 9 of the rear window 1 can use any conceivable type of fasteners or fastening techniques. Some examples of fastening techniques that don't use fasteners may include adhesives, fusions, or similar techniques.

The connection described in FIGS. 2 through 5 between the flexible covering 7 and the rear window 1 can be further supplemented by an additional interior connection point, corresponding fastening section, and corresponding offset. The connection point can be provided in the vehicle interior opposite the offset 11, and can be used to fasten an interior ceiling of the vehicle 5 to the vehicle roof 3. This connection point makes it possible to cover the functional elements of the connection and the functional elements of the kinematics which are necessary for adjusting the vehicle roof 3.

While embodiments of the invention have been illustrated and described, it is not intended that these embodiments illustrate and describe all possible forms of the invention. Rather, the words used in this specification are words of description rather than limitation, and it is understood that various changes may be made without departing from the spirit and scope of the invention.

What is claimed is:

1. A rear window in combination with a rear roof section of an openable roof vehicle having a flexible covering, the combination comprising:
the rear window being formed of a transparent plastic material and having a fastening section for connecting the rear window to the flexible covering; and
wherein the fastening section is integrally formed with the rear window and defines a portion that is offset relative to the plane of a surface of the rear window.

2. The combination of claim 1 wherein the rear window is manufactured by injection molding.

3. The combination of claim 1 wherein the portion that is offset receives the flexible covering and a fastener secures the flexible covering to the peripheral portion.

4. The combination of claim 1 wherein an outside surface of the flexible covering and an outside surface of the rear window meet at the fastening section of the rear window, wherein the outside surface of the flexible covering is flush with the outside surface of the rear window.

5. The combination of claim 1 wherein the difference in wall thickness of the rear window in the area of the offset is less than the wall thickness in a middle area of the window.

6. The combination of claim 1 wherein the fastening section contains a step that has a thinner wall thickness than the rest of the rear window.

7. The combination of claim 1 wherein the offset is defined by a bend in the rear window.

8. The combination of claim 1 wherein the fastening section has an upward bend at a peripheral edge of the rear window.

9. The combination of claim 8 wherein the upward bend forms an angle up to 90° with the surface of the rear window.

10. The combination of claim 1 wherein the rear window is made of polycarbonate material.

11. The combination of claim 1 wherein a localized area of the rear window has a wide angle lens that is integrally formed by injection molding the rear window.

12. A rear window for a vehicle having a retractable roof in combination with a rear roof section of the vehicle, the combination comprising:
the rear window being formed of a transparent plastic material and having an outer surface and an offset portion that is recessed and parallel to the outer surface, wherein the offset portion extends around at least part of the periphery of the rear window;
a wide angle lens integrally formed in the rear window;
the rear roof being secured to the offset portion of the rear window with the outer surface of the rear window being flush with the rear roof section around the periphery of the rear window.
